(19) United States
(12) Patent Application Publication
(10) Pub. No.: US 2026/0151300 A1
(43) Pub. Date: Jun. 4, 2026

(54) MAINTAINING MEDICINE QUALITY IN MEDICINE PREPARATION

(71) Applicant: Thorne Intellectual Property Holdings, LLC, Bountiful, UT (US)

(72) Inventors: Gale Harrison Thorne, JR., Bountiful, UT (US); Gale Harrison Thorne, Bountiful, UT (US); Kendall Patterick Thorne, Layton, UT (US)

(73) Assignee: Thorne Intellectual Property Holdings, LLC, Bountiful, UT (US)

(21) Appl. No.: 18/831,813

(22) Filed: Sep. 15, 2025

Related U.S. Application Data
(63) Continuation-in-part of application No. 18/831,353, filed on Dec. 2, 2024.

(51) Int. Cl. A61J 1/10; A61J 1/16; B65B 7/02; B65B 55/10

(52) U.S. Cl. CPC A61J 1/10; A61J 1/16; B65B 7/02; B65B 55/10

(57) ABSTRACT

Convenience kits with appropriate safeguards for preparing medicine, especially medicine which cannot be further sterilized, for use in providing medicine preparations in such patient treatment containers as TPN modules, an elastomeric balls, IV bags and syringes is disclosed. A combined sterilizer/Header Bag sealer and a special tool for accessing medicine source containers and decapping and capping syringes are also disclosed.

### CONTINUATION-IN-PART

This U.S. Patent Application is a Continuation-in-Part of U.S. patent application Ser. No. 18,831,353 titled: SYRINGE BASED EMERGENCY MEDICINE PREPARATION CONVENIENCE

### FIELD OF INVENTION

Generally, the field of invention is related to methods and apparatus used to provide convenience kits for use in safe and effective medicine preparation. As each medicine preparing kit must be able to be used as a separate and self-contained product, in environments which may be neither sterile nor otherwise controlled, the field is also related to methods and apparatus which provide inherent safeguards for assuring that both the sterility and the quality of medicine are protected while providing a desired degree of safety and efficacy for those who use the kits.

### DESCRIPTION OF RELATED ART

Reference is made to U.S. Pat. Nos. 10,555,872; 10,940,087; 10,800,558; 11,312,605; 12,064,394 and 12,121,693, each of which discloses and claims convenience kits having unique methods and apparatus for sterilizing and preparing medicine in plastic bags for patient use. In each patent, primary inherent safeguards are a closed plastic bag and a filter assembly which are major parts of each convenience kit.

A safeguard is defined as technology or process which assures both safety and efficacy for intended use which includes protective safety for both the convenience kit user and patient who receives medicine prepared using the convenience kit.

Providing safeguards is a common and expected process in medicine preparation wherein at least one safeguard is provided for assuring safety and efficacy for each medicinal preparation.

In modes of operation of the above referenced patents, each kit, of the above referenced patents, utilizes a combination of items used to prepare and communicate medicine displaced into a plastic bag which is commonly sealed and sterilized, before use, with all bag resident components to provide inherent safeguards.

An additional safeguard for the above referenced U.S. Patents is a provision of only one pathway for material entry into the otherwise closed, sealed and pre-sterilized plastic bag. The pathway provides for fluid passage through a sterilizing grade medical filter. Thereby, all matter disposed within the bag is provided in a sterile state providing an inherent safeguard which assures achieving and maintaining a guaranteed sterility assurance level (SAL) of all matter in the bag, including the medicine being prepared. These safeguards have proved effective with over five years of kit use having been passed without a single recorded complaint resulting from safeguard deficiency. While this approach and these safeguards have proved effective for medicines which can be sterilized by passage through a sterilizing grade filter, molecular sizes and other factors often preclude use of the above disclosed filter sterilization technology in medicine preparation. A significant portion of contemporary medicine cannot be sterilized by filtering. Such medicines are generally provided confined in a predetermined sterility state within a closed vessel, but medicine preparation is often left to be performed by kit-free processes, such as by using laminar flow hoods used under strict regulations.

As mentioned supra, all medicine preparation should be validated for sterility and maintenance of desired medicinal state using some form of a safeguard. In the case for laminar flow hoods, safeguard protection is commonly in the form of testing samples of a current procedure selected at a predetermined statistical sampling rate. Because safeguard testing of laminar flow hood products is commonly manufactured as individual hand-prepared processes, and a single fault or error can result in contamination of just a single product unit, statistically employed safeguards such as destructive sample testing cannot be considered dependable.

For those medicines which cannot be filter sterilized, entirely different medicine preparation and safeguard methods must be employed. Even so, medicine sterility and quality must be maintained and protected. As each preparation is subject to various conditions and processes, each individual convenience kit must provide environmental conditions which are conducive to maintaining the quality and the sterility of the medicine being prepared and effective safeguards must be in place to assure such in each individual convenience kit.

### Definitions of Terms Used is This Specification

at least one, n: one or more
convenience kit, n: a kit made and dedicated for preparing one or more medicines, one preparation at a time, for ready use in patient treatment. Each such kit being designed and fabricated to meet FDA convenience kit regulations. Every kit is made to be used separately, comprising a plastic Bag (which is preferred to be a Header Bag which acts as a key safeguard) and necessary medicine preparation tools including vessels and component parts, some of which may be disposed outside the plastic bag, thereby, providing complete capacity for safe and effective medicine preparation including inherent safeguards for preparation safety and quality.
safeguard, n: “technology or process which assures safety and efficacy for an intended use”.
Header Bag, n: medical enclosure plastic bags made with a Tyvek7 patch, and otherwise laminated with clear transparent, weight-resistant polyethylene or similar material. As is the case with all plastic bags used within the scope inventions disclosed herein, a single bag opening can be tightly sealed to maintain the integrity of packaging. Tyvek7 is a filter material provided as a Header Bag opening covering patch which provides for passage of small molecular sized particles but is impervious to all other matter. As the meaning of the term Tyvek7 is a well known reference material, the function of which is also well known, the term Tyvek7 is used as a reference for all generic and other materials which provide the filtering quality and other desired functions currently accredited to Tyvek7. All material plastic bags selected for use in this application should be sufficiently pliant for exterior digital displacement and handling of parts and devices disposed within the bag, after sealing without, in any way breaching the bag. As is typical of Header Bags, all plastic bag material should also be sufficiently sturdy to be used as a part contacting and handling medium without being accidentally breached, thus performing as an effective safeguard. In addition, because parts are handled with only contact with the exterior of the bag, space within the bag may be restricted due to transport packing considerations. In such cases, usable space within each Header Bag can be further increased by “tenting” one side of the bag relative to the other, with required air communication displaced into the bag, being filtered air provided by the Tyvek7 patch.
raw. adj: applied to untreated medicine generally provided in a closed container which should be considered to have an inherent SAL and medicinal quality which must be maintained throughout each step in a process of medicine preparation.
SAL, n: Sterility Assurance Level
vessel, n: a medical preparation and dispensing container which can be accessed for medicine preparation and closed and sealed before being disposed in a potentially contaminating environment.

### BRIEF SUMMARY AND OBJECTS OF THE INVENTION

In brief summary, medical preparations made according to novel methods and apparatus according to the instant inventions disclosed herein alleviate all of the known problems related to providing safe and effective convenience kits and associated methods of use which provide effective safeguard protection for medications and medicine preparation especially for medicines which cannot be sterilized by filtration or other sterilizing methods such as by heat, light or forms of radiation. Each convenience kit design comprises use of a Header Bag or plastic bag equivalent wherein raw medicine is sealed and closed for preparation and packaging for patient use and for apparatus and methods for sterilizing exposed surfaces within the plastic bag which assures all surface-to-surface component contact is between surfaces which meet a desired SAL.

It is therefore a necessary object to provide a method of sterilization within the plastic bag which provides an effective safeguard by obviating cross contamination between or among items or other matter disposed within the plastic bag of the associated convenience kit without affecting SAL or medicinal state of medicine disposed therein.

It is therefore a very important object to provide a mode of container surface sterilization which will obviate cross contamination without affecting sterility or quality of medicine in an associated closed container.

It is a principal object to provide convenience kits with necessary inherent safeguards which assure maintenance of desired medicinal quality and sterility of medicine being prepared.

It is a major object that each convenience kit provides the necessary inherent safeguards for assuring desired quality and sterility as self-contained convenience kit attributes.

It is an essential object to provide convenient kits which provide desired SAL operating environments without affecting sterility or quality of medicine in a resulting preparation.

It is another essential object to provide a sterilization safeguard which assures an SAL within said Header Bag which obviates cross-contamination.

It is a fundamental object to provide convenient kits having a scope of use which includes providing convenient kits for sterilizing only exteriors of containers selected from a group of containers including liquid containing IV bags, TPN modules, medical syringes and elastomeric balls without affecting medicinal quality or sterility of medicine being prepared.

It is another fundamental object to provide at least one individual convenient kit for each medicine selected from a group of medicines including Propofol, X/Ray dyes, Lipids, blood products and a variety of Chemo drugs.

It is a strongly desired object to provide tools for preparing and storing medications within patient treatment implements from only contact with an exterior surface of a Header Bag, such tools being characterized by ease of use and providing safeguards for assuring access to medication provided in source containers disposed within a Header Bag.

Accordingly, it is a primary object to provide a variety of convenience kits, each convenience kit often being designed and fabricated for a particular individual or selected drug preparation and used but once.

It is a basic object to provide medicine preparation convenience kits which have effective inherent safeguards for protecting kit users as well as medicine being prepared.

### BRIEF DESCRIPTION OF THE DRAWINGS

FIG. 1 is a Flow Chart depicting steps for assembling convenience kits made according to the present invention.

FIG. 2 is a Flow Chart depicting steps for using convenience kits made according to the present invention.

FIG. 3 is a side elevation of a convenience kit made according to the present invention with an IV bag disposed in a Tyvek7 Header Bag and other components exterior to the Header Bag including a filter assembly affixed to the Header Bag. Components exterior to the Header Bag consist of an exterior source syringe, a vial containing medicine concentrate and a syringe cap, any or all of which may be supplied by a user.

FIG. 3A is a perspective of a port additive device which is commonly used for communicating fluids into an IV Bag which provides a needle shield for providing a safeguard for use of a sharp object within the Header Bag.

FIG. 3B is a diminished side elevation, similar to FIG. 3, illustrating displacement of components exterior to the Tyvek7 bag for communicating medicine from an exteriorly disposed vial into an exterior source syringe.

FIG. 3C is a side elevation, similar to FIG. 3B illustrating the exterior source syringe affixed to the filter assembly and to an IV port adapter affixed to the filter assembly for communicating medicine from the exterior source syringe into the IV bag.

FIG. 3D is a side elevation, similar to FIG. 3C, in which medicine has been communicated from the exterior source syringe into the IV bag.

FIG. 3E is a side elevation, similar to FIG. 3D, wherein the IV bag is displaced from the port adapter.

FIG. 3F is a side elevation, similar to FIG. 3E, wherein the IV bag is displaced from the Header Bag.

FIG. 3G is an exploded view of a PRIOR ART filter assembly.

FIG. 3H is a side elevation of an assembled PRIOR ART filter assembly affixed to a portion of a plastic bag.

FIG. 4 is a side elevation of a convenience kit made according to the present invention provided with a Tyvek7 Header Bag containing a TPN module disposed apart from a port access adapter comprising a safeguard needle shield which is affixed to a filter assembly affixed to provide the only liquid pathway into the Tyvek7 bag and four exteriorly disposed components comprising a medical syringe and three medicine containing vials. The exterior components may be provided by the user.

FIG. 4A is a side elevation similar to FIG. 4, but diminished in size, wherein the syringe is affixed to a selected vial and inverted for accessing contents from the selected vial.

FIG. 4B is similar to FIG. 4A wherein the syringe as seen is detached from the selected vial and affixed to the filter assembly for communicating syringe contents into the TPN module via communication with the port access adapter.

FIG. 4C is a side elevation, similar to FIG. 4B, comprising status of vials individually emptied and associated medicine communicated into the TPN module which is displaced for use from the Header Bag.

FIG. 5 is a side elevation of a convenience kit made according to the instant invention with an elastomeric ball and an associated IV line disposed in a Header Bag, the Header Bag being fitted with a filter assembly and other components including a vial adapter, a vial, a syringe and a syringe cap disposed exterior to the Header Bag.

FIG. 5A is a diminished side elevation view of the convenience kit seen in FIG. 5 with the syringe affixed to access medicine from the vial.

FIG. 5B is a view of the convenience kit seen in FIG. 5A with the syringe filled and affixed to the filter assembly which is further affixed to the elastomeric ball.

FIG. 5C is a view similar to FIG. 5B with medicine displaced from the syringe into the elastomeric ball.

FIG. 5D is a view similar to FIG. 5C with the elastomeric ball and IV line displaced from the header bag.

FIG. 6 is a side elevation of a convenience kit made according to the instant invention with all but one component being disposed within a Tyvek7 Header Bag, that component being an enlarged bag clip (similar to a paper clip, but much larger) which is disposed for keeping selected components disposed within the Header Bag separated. Inside the Header Bag all the components are required for preparation of a medicine, including a medical syringe, which is filled with a medicine additive, a vial adapter, a vial containing medicine needing an additive, an IV port adapter and a partially filled IV bag.

FIG. 6A is a side elevation similar to FIG. 6, but diminished in size with syringe and vial adapter affixed to the vial.

FIG. 6B is a side elevation similar to FIG. 6A with syringe, vial adapter and vial rotated for withdrawing liquid from the vial.

FIG. 6C is a side elevation similar to FIG. 6B with the bag clip displaced for better access for affixing the filled syringe to the IV bag.

FIG. 6D is a side elevation similar to FIG. 6C with contents of the syringe communicated into the IV bag.

FIG. 6E is a side elevation similar to FIG. 6D with the IV bag displaced from the Tyvek7 Header Bag.

FIG. 7 is a side elevation of a convenience kit made according to the instant invention with all components being disposed within a Tyvek7 Header Bag, the components being an IV bag, a syringe (a source syringe) fitted with a dripless connector, a vial adapter, a vial filled medicine to be communicated into the IV bag and an IV bag port adapter.

FIG. 7A is a diminished side elevation similar to FIG. 7, but with the vial affixed to the vial adapter.

FIG. 7B is similar to FIG. 7A, but with the syringe and dripless connector affixed to the vial adapter.

FIG. 7C is similar FIG. 7B with medicine displaced into the source syringe.

FIG. 7D is similar to FIG. 7C with the source syringe and dripless connector displaced from the vial adapter.

FIG. 7E is similar to FIG. 7D, but with the syringe affixed to the port adapter.

FIG. 7F is similar to FIG. 7E, but with medicine from the syringe dispensed into the IV bag.

FIG. 7G is similar to FIG. 7F, but with the syringe and dripless connector displaced from the IV port adapter.

FIG. 7H is similar to FIG. 7G, but with the so filled IV bag displaced from the Header Bag.

FIG. 8 is a side elevation of a convenience kit made according to the instant invention with all components being disposed within a Tyvek7 Header Bag. The components being a partially filled IV bag, a port additive device for being affixed via a “T” connector to a dripless connector and an IV link. Also, packaged separately in the Header Bag is a plurality of parts providing access to a vial (disposed within the Header Bag), a vial drawing syringe, a flushing syringe and associated interconnecting components.

FIG. 8A is a diminished side elevation similar to FIG. 8, being assembled with the vial adapter affixed to the vial and the port additive device affixed to the IV bag and the flush syringe affixed to communicate with the “T” connector.

FIG. 8B is a side elevation similar to FIG. 8A with medicine within the vial displaced into the vial drawing syringe.

FIG. 8C is a side elevation similar to FIG. 8B with a stopcock rotated to permit medicine from the vial to be delivered into the IV bag.

FIG. 8D is a side elevation similar to FIG. 8C with a second stopcock rotated to permit flush to be delivered into tubing and into the IV bag.

FIG. 8E is a side elevation similar to FIG. 8D but with separated IV bag and IV link displaced for patient use.

FIG. 9 is a side elevation of a convenience kit made according to the instant invention with all components being disposed within a Tyvek7 Header Bag, the components being a hangar assembly affixed to a vial and a syringe and fitted with an IV bag port access device which is further affixed to an IV bag.

FIG. 9A depicts the hangar seen in FIG. 9, laid flat and diminished in size.

FIG. 9B is a frontal elevation of the hangar seen in FIG. 9A folded for use.

FIG. 9C is similar to FIG. 9, but with a TPN module affixed to the hangar.

FIG. 9D is similar to FIG. 9C but with an IV bag affixed to the hangar.

FIG. 10 is a perspective line drawing of a sterilizing mechanism made according to the present invention juxtaposed to a plastic bag sealing mechanism, each mechanism having a hinged bar for clamping a portion of a Header Bag closed as seen in the referenced drawing.

FIG. 10A is perspective similar to FIG. 10, but without the sealing mechanism.

FIG. 10B is a perspective similar to FIG. 10, but with a bag holding bar lowered and disposed against the Header Bag; a double arrow indicating an angle of vibration is also shown.

FIG. 10C is a perspective similar to FIG. 11A, but with both the sterilization bar and a sealing bar, of the associated sealer lowered into contact with the Header Bag.

FIG. 10D is a perspective of the Header Bag with a proximal portion being removed after sealing.

FIG. 10E is a block diagram disclosing function and control parts for sterilizing inside a Header Bag as seen in FIG. 10B.

FIG. 10F is a block diagram similar to FIG. 10E disclosing function and control for a gas inflation cycle.

FIG. 10G is a block diagram similar to FIG. 10F disclosing function and control for a gas exhaust cycle.

FIG. 10H is a block diagram similar to FIG. 10G with controls set for ending the sterilization cycle.

FIG. 11 is a line drawing of a convenience kit made according to the present invention comprising a closed and sealed Header Bag containing a plurality of capped syringes each of which is pre-sterilized, a vial which provides a source container for medicine which is to be repackaged, a tool used for accessing both the vial and the syringes and a dripless connector which is a safeguard against spillage.

FIG. 11A is a side elevation line drawing of the vial and tool seen in FIG. 11, but seen with the Header Bag removed for a preferred visual presentation.

FIG. 11B is a line drawing similar to FIG. 11A, but with the tool disposed for being affixed to the vial.

FIG. 11C is a line drawing similar to FIG. 11B, but with the tool rotated for visualizing the side of the tool which is designed to join the tool to the vial.

FIG. 11D is a line drawing with the tool affixed to the vial.

FIG. 12 is a side elevation line drawing of the vial affixed to the tool which is further affixed to a cap of an associated syringe.

FIG. 12A is a side elevation similar to FIG. 12, but with the capped syringe displaced within the tool.

FIG. 12B is a side elevation similar to FIG. 12A, but with the syringe uncapped and displaced to be affixed to the dripless connector which is affixed to the tool and thereby to the vial.

FIG. 12C is a side elevation similar to FIG. 12B, with the syringe emptied of gas delivered into the vial.

FIG. 12D is a side elevation similar to FIG. 12C, with the vial and syringe inverted.

FIG. 12E is a side elevation similar to FIG. 12D, with a bolus of medicine draw from the vial into the attached syringe.

FIG. 12F is a side elevation similar to FIG. 12E with the syringe displaced from communication with the vial and affixed to the cap.

FIG. 12G is a side elevation similar to FIG. 12F, but with the capped syringe displaced from the tool.

### DETAILED DESCRIPTION OF THE ILLUSTRATED EMBODIMENTS

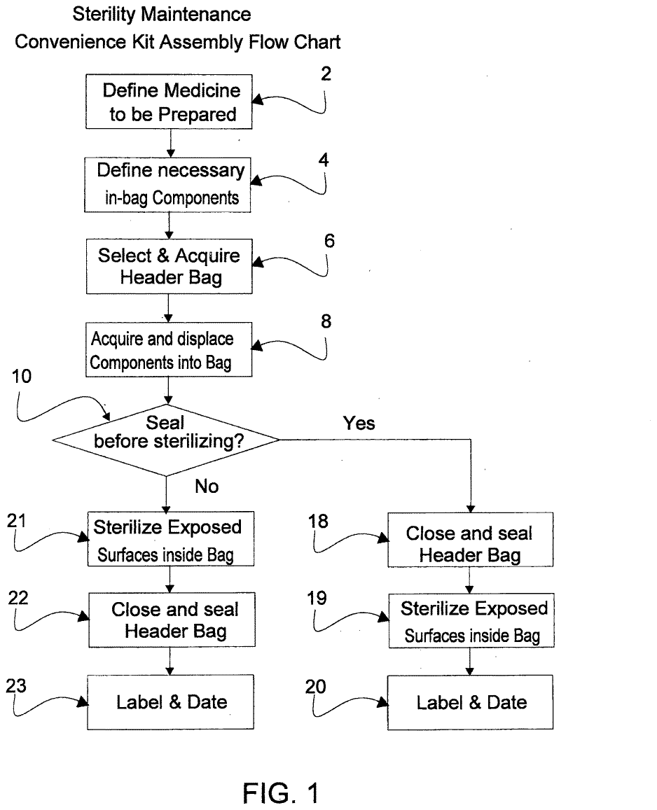

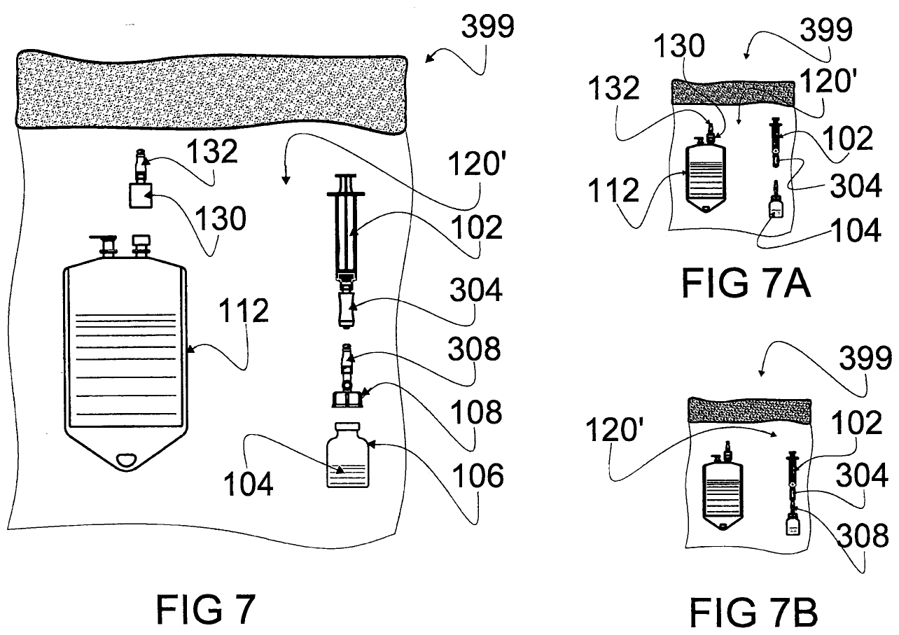

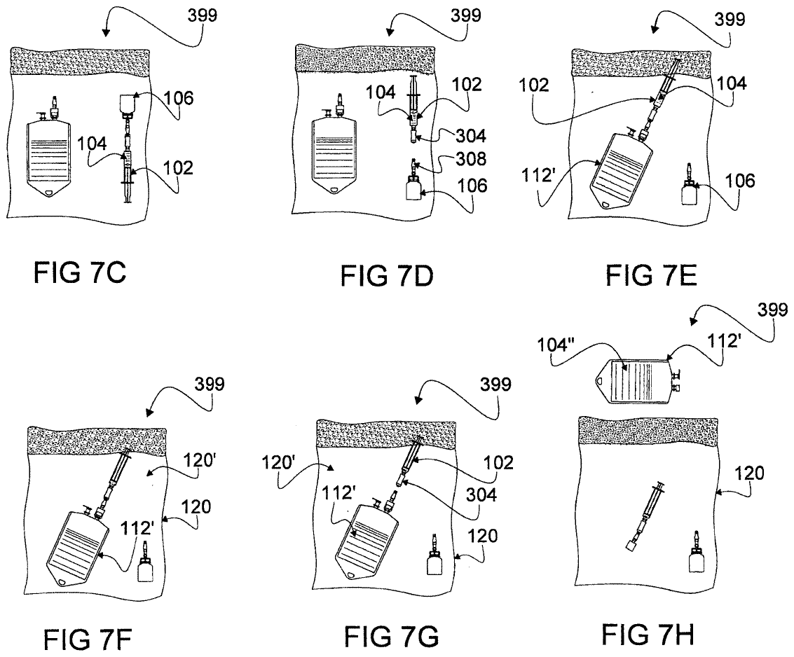

In this description, the term proximal, when used, indicates the segment of the device normally closest to the object of a sentence describing its position. The term distal, when used, refers to a segment away from being proximal. Reference is now made to embodiments illustrated in FIGS. 1-12G wherein like numerals are used to designate like parts throughout and primed numerals are used to represent parts which are similar to parts numbered without primes, but have differentiating characteristics as defined in the text.

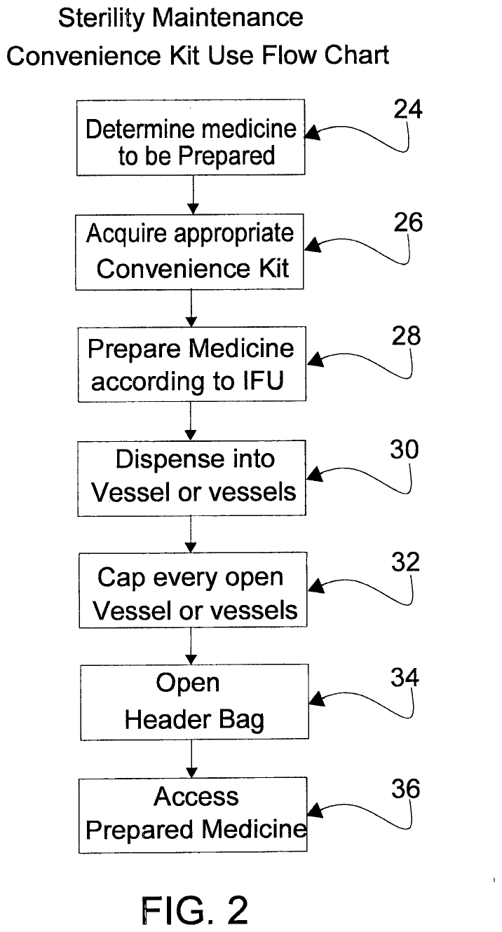

Reference is now made to FIGS. 1 and 2 where block diagrams portray steps in making and using convenience kits made according to the present invention. In general, convenience kits made according to the present invention, employ Header Bags, as defined supra. Header Bags are used because they can not only be sealed to provide a sterile and safe environment for preparing medicine, but have a Tyvek7 patch, through which gas, both sterilizing and sterilized can be applied against surfaces of closed and sealed containers disposed within the Header Bag. By this process, exteriors of medicine containers can be sterilized to a desired SAL without impacting medicinal quality or sterility of medicine disposed within the containers. Raw medicine provided for compounding and disposed within the containers is thereby made free of detrimental contamination as components are compounded. Of course, medicine within the containers is provided at an SAL which is acceptable to being compounded with other medicine delivered in the same state with each such container by sterilizing container exteriors and the interior of a closed and sealed Header Bag sources of contamination are severely limited to contents of the containers themselves. Thus, such convenience kits can be used to safely and efficiently prepare medicine in a totally enclosed Header Bag which provides inherent safeguards for medicine preparation without requiring more sophisticated tools such as a laminar flow hood.

Step 2 in FIG. 1 instructively indicates each convenience kit is specially designed for a particular preparation purpose and is used but once. Step 4 instructs careful selection of components to assure FDA convenience kit requirements are met. As disclosed supra, a Header Bag provides protected space wherein each preparation is made as defined in Step 6.

All preparations are accomplished using components disposed in the Header Bag as indicated in Step 8.

To accomplish a safe and effective medical preparation, each Header Bag and components therein must not communicate any degrading (i, e. lowering sterility or cross contaminating with non-sterile media) contact. Header Bags should be sized for expected space requirements. All bagged components should be disposed within the Header Bag before sterilization. Blocks 2-8 define widely varied preparation steps based upon each particular medicine the convenience kit is made to use in medicine preparation.

However, the most important step is sterilizing. Two methods for sterilizing are disclosed hereafter. The first step occurs after the Header Bag is closed and sealed as indicated in step 18. The method utilizes filtering capability of the Tyvek7 patch for a transmitting source of sterilizing gas (Hydrogen Peroxide) to sterilize exposed surfaces inside the Header Bag as indicated in Step 19. Such services are available commercially via such facilities as STERIS' Biodecontamination Unit VHP MD140™. STERIS is a large sterilizing company with facilities available across the United States.

The second method begins as defined in Step 21 by directly spraying a gas such as Hydrogen Peroxide into a still unsealed Header Bag, filled with components and using a sterilizer/sealer tool as disclosed in detail hereafter. As is standard operating procedure, see steps 20 and 23, each so finished product should be properly labeled.

Reference is now made to FIG. 2 for general information related to use of convenience kits made according to the present invention. Generally, such convenience kits are easy to use for each preparation to be provided with instructions for use (IFU's) provided with each convenience kit.

Based upon medicine to be prepared, a convenience kit modeled precisely for that medicine should be used. As it is expected that each facility so engaged would have an inventory of convenience kits for various preparations, the first steps, 24 and 26 are selection steps for the medicine and the appropriate kit. Specific examples of kit use are detailed hereafter, therefore, use disclosed herein is briefly disclosed as steps 28, 30 and 32, but emphasis should be given to understanding that, for step 30, each vessel would have to be accessed from a closed state which is the state provided for permitting gas sterilization of the exterior of all vessels with some form of medicine already disposed therein and the reason for closing the vessel is for maintenance of SAL and medicinal quality. Understanding that the inside of the Header Bag and exteriors of all vessels are sterilized and thereby are provided with a predetermined exterior SAL.

Per decision block 10 in FIG. 1, convenience kit final assembly, before use, is consummated by sterilization and sealing components within a Header Bag as a primary safeguard. Understanding of the character and requirements of each particular medicine or medicines related to being sterilized significantly affects which mode of sterilization should be used to provide the kit with an appropriate sterilization safeguard.

Blocks 21-23 are for sterilization processes where sterilization occurs before bag sealing. Blocks 18-20 disclose sealing steps post sterilization.

Size and capacity of a selected Header Bag can vary based upon mode of preparation, quantity of vessels to be filled, and vessel filling support devices, for example, as part of Header Bag selection and acquisition as instructed in execution block 8. Keep in mind that each kit must be self-sustaining, meet FDA convenience kit regulations and provide the necessary safeguards to assure safety and efficacy of medicine preparation. Therefore, care must be taken in component selection and acquisition when providing components as instructed in execution of block 4.

Once all components and other material required for medicine preparation are acquired, the Header Bag is closed and sealed as instructed in execution blocks 21-22 and 18-19 to provide a critical safeguard.

An important safeguard is provided against cross contamination among parts disposed within the sealed Header Bag by infusing a surface sterilizing gas via a filter assembly or other bag opening pathway or through the Tyvec7 patch. As disclosed in detail hereafter, there are two general methods for sterilizing kits made according to the present invention, both methods employ a sterilizing gas, such as H₂O₂. Through the use of a sterilizing gas, only exposed exteriors of all components within the Header Bag are affected, allowing materials which are pre-stored in closed containers to be unaffected.

As instructed in execution blocks 20 and 23 followed by properly labeling the so completed kit is ready for use.

An exemplary process for using a kit made according to inventive instructions found herein is provided in FIG. 2. Since it is likely more than one medicine and, therefore, more than one convenience kit for medicine preparation be available in a given inventory, it is important to note proper labeling and attention should be employed to assure a proper convenience kit is selected for use as instructed in execution block 24 and acquired (execution block 26). As a safeguard each convenience kit should be clearly labeled and marked with identifying information.

As is customary for every medical appliance, an Instruction for Use (IFU) should be provided for each convenience kit and followed for medicine preparation as instructed in execution block 28. Once the medicine is ready for being communicated into a vessel or vessels, it is so dispensed (see instruction block 30) by digital action from outside the Header Bag (the bag enclosure providing an important safeguard).

Further, to provide a final safeguard, each vessel is capped and sealed by digital contact only with the exterior of the Header Bag to provide protective closure against medicine contamination as instructed by execution block 32. With that final safeguard in place, access to the vessels containing the medical preparation is provided by opening the Header Bag as instructed by execution block 34.

It is now possible, to access filled vessels from the Header Bag to be delivered with safety and efficacy to a point of use as instructed by execution blocks 34 and 36.

Following are examples of convenience kit forms, contents and uses with attention paid to associated safeguards and provisions of convenience kits made in accordance with instant inventions disclosed herein.

### EXAMPLE 1: AN IV BAG AS A VESSEL IN A MEDICINE PREPARATION CONVENIENCE KIT WHICH IS A “HYBRID” CONVENIENCE KIT FORMED, IN PART, BY ITEMS IDENTIFIED AS PRIOR ART AND ITEMS WHICH ARE NEW ITEMS CLAIMED IN THIS U.S. PATENT APPLICATION

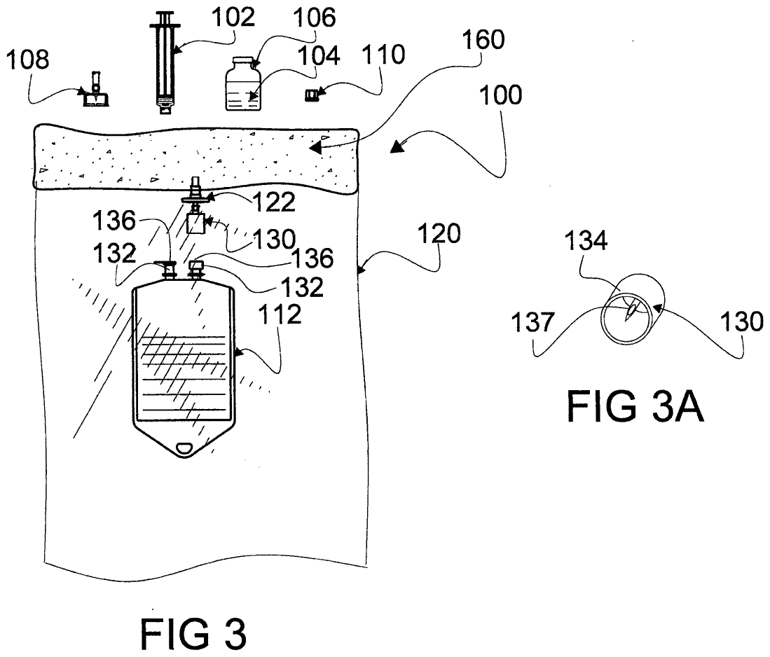

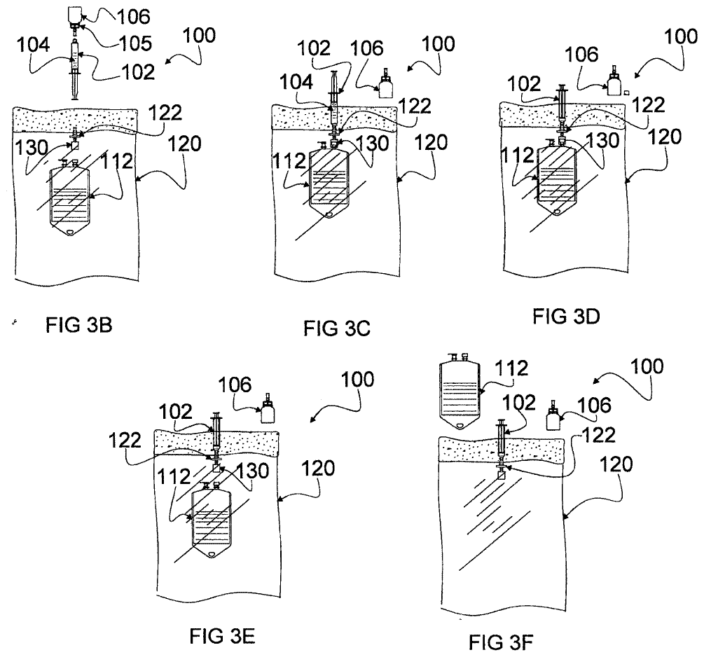

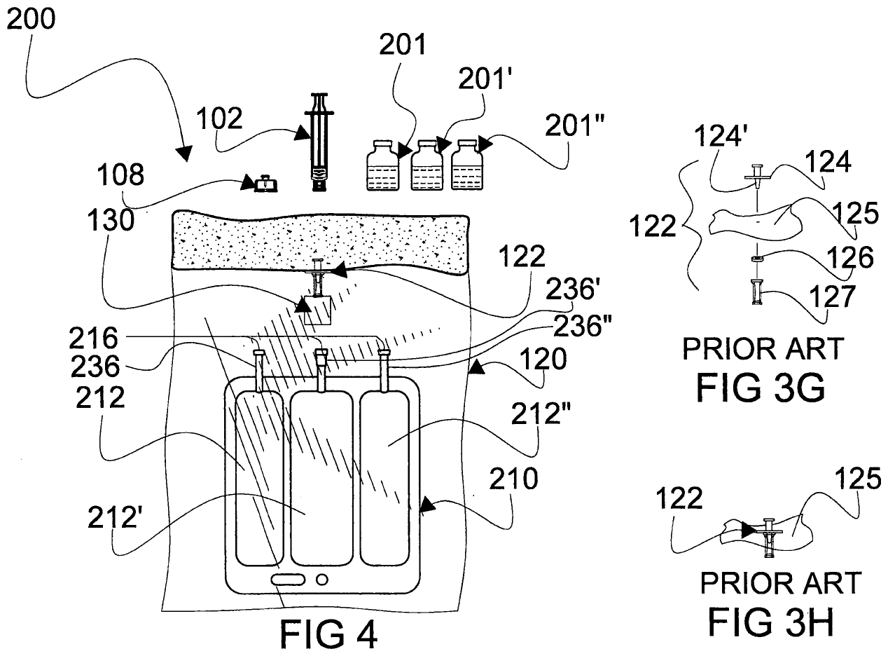

Reference is made to FIGS. 3-3A wherein a convenience kit 100 made according to the instant invention is seen. At first glance, kit 100 appears to be qualified as a PRIOR ART filter sterilizing convenience kit by filter sterilizing raw medicine 104 drawn from vial 106. Vial 106, syringe 102, vial adapter 108 and syringe cap 110 along with a filter assembly 122 affixed to Header Bag 120 all are items which could be a part of a PRIOR ART sterilizing convenience kit. However, affixed to filter assembly 122 is an IV bag port adapter 130 and resident inside Header Bag 120 is an IV bag 112. Medicine 104 from inside vial 106 can be sterilized by filtering, but medicine inside IV bag 112 cannot. As is the case with all medicine containers in which medicine compounding takes place within the scope of instant invention disclosed herein, each container has at least one port 132. Each such port 132 has a pierceable septum 136 as seen in FIG. 3. By piercing a septum 136, fluid flow is permitted through septum 136 via a sharpened medical needle 137. When the piercing needle 137 is removed from septum 136, fluid flow through septum 136 is obstructed.

As seen in FIG. 3A, port adapter 130 has a sharp needle 137 shrouded, for a safeguard by a needle shield 134. In this example, port adapter 130 is affixed, inside Header Bag 120, to filter assembly 130. All exposed surfaces interior to Header Bag 120 including IV bag port adapter 130 and IV bag 112 are provided previously sterilized by a sterilizing gas such that fluid inside IV bag 112 is not affected by any sterilizing agent with ports 136 closed and sealed. Thus, with safeguards in place including all exposed surfaces sterilized and sterilized medicine 110 from vial 106, convenience kit 100 is qualified as a novel convenience kit 100 made according to the present invention by not requiring medicine originally disposed in IV bag 112 to be affected by any sterilizing medium.

Simplistically, FIG. 3B shows medicine 104 being drawn from vial 106 into syringe 102. FIG. 3C shows syringe 102 affixed to filter assembly 122. FIG. 3D shows medicine being dispensed into IV bag 112. FIG. 3E shows IV bag 112 displaced from port adapter 130 and FIG. 3F shows IV bag 112 displaced from Header Bag 120 for use.

Note that needle 137 of port adapter 130 disposed within Header Bag 120 has all exposed surfaces inside Header Bag 112 sterilized by sterilizing gas and can provide a safeguarded pathway for medicine from vial 104 to be delivered through port 136 without contaminating contents of IV bag 112. In this example, an IV bag 112 is provided as the exemplary closed vessel. While applications for use are broad, classes of medicines which are commonly involved are antibiotics and steroids.

Header Bag 120 is seen to have a filter assembly 122 affixed thereto. Such filter assemblies as filter assembly 122 affixed to a plastic bag are PRIOR ART, see U.S. Pat. No. 12,064,394 B1 and a recently submitted U.S. Patent Application titled A METHOD FOR MAKING A HARDY PLASTIC BAG FILTER ASSEMBLY, U.S. patent application Ser. No. 18,831,400.

As is true of all convenience kits made according to the present invention, each vessel (in this example, i.e. IV bag 112) can be provided filled with a medicinal aliquot or empty, but in all cases fluid in each vessel is kept at a predetermined medicinal quality and sterility level by having only the exterior surface of IV bag 110 sterilized which is necessary to retain original medicinal state.

### Prior Art: Filter Assembly 122 (see FIGS. 3G and 3H.)

For reference, because the Filter Assembly 122 is a constructed part, details of which are not generally available as a purchased unit, an exploded view and an assembled view are provided as FIGS. 3G and 3H. As seen in FIG. 3G, a sterilizing medical filter 124 is affixed to a Header Bag (at bag part 125) by a gasket 126 disposed about a fitting portion 124′ and anchored by a fitting 127. An assembled filter assembly 122 is seen in FIG. 3H.

### EXAMPLE 2: CONVENIENCE KIT PROVISIONS FOR TPN MEDICATIONS

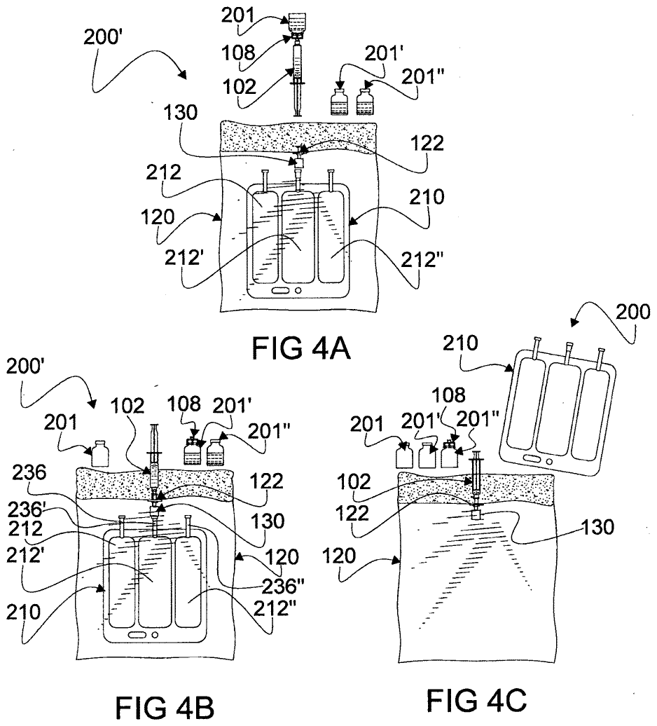

Reference is made to FIGS. 4-4C wherein method and apparatus for providing TPN based medication with safeguard protection is seen. In this example, raw medicine from multiple vials (numbered 201,201′,201″) is communicated to a TPN module through a filter assembly 122 to assure sterility of the medicine, TPN module 210 provides three separate vessel pods numbered 212, 212′ and 212″ each having an access port, numbered 236, 236′ and 236″, respectively and seen in FIG. 4B. Medicine which may be pre-stored in the TPN modules includes amino acids, lipids, and dextrose. Vials containing adaptive solutions may be electrolytes, trace elements and vitamins which are able to be sterilized by filtering and seen external to Header Bag 120. In this example, three vials (numbered 201, 201′ and 201″), a vial adapter 108 and a medical syringe 102 are seen exterior to Header Bag 120. Externally disposed items may be provided by a user.

As seen in FIG. 4, a convenience kit 200 comprises a Header Bag 120 with a filter assembly 122 affixed to a port adapter 130 as shown in example 1. A TPN module 210 is disposed within Header Bag 210 which thereby provides a safeguard. Exposed surfaces of TPN module 210 and port adapter 130 are made sterile by exposure to a sterilizing gas.

As seen in FIG. 4A, liquid is drawn from vial 201 into source syringe 102. In FIG. 4B source syringe 102 is affixed via filter assembly 122 and port adapter 130 to a medially disposed preselected port 236′ of ports 236, 236′ and 236″ available. As seen in FIG. 4C, with vials 201, 201′ and 201″ emptied and associated contents communicated into TPN module 210, Header Bag 120 is opened and TPN module 210 removed for use with initial medication disposed in TPN module ready for use in initial medical state.

### EXAMPLE 3: CONVENIENCE KIT. ELASTOMERIC BALLS AND HAZARDOUS DRUGS

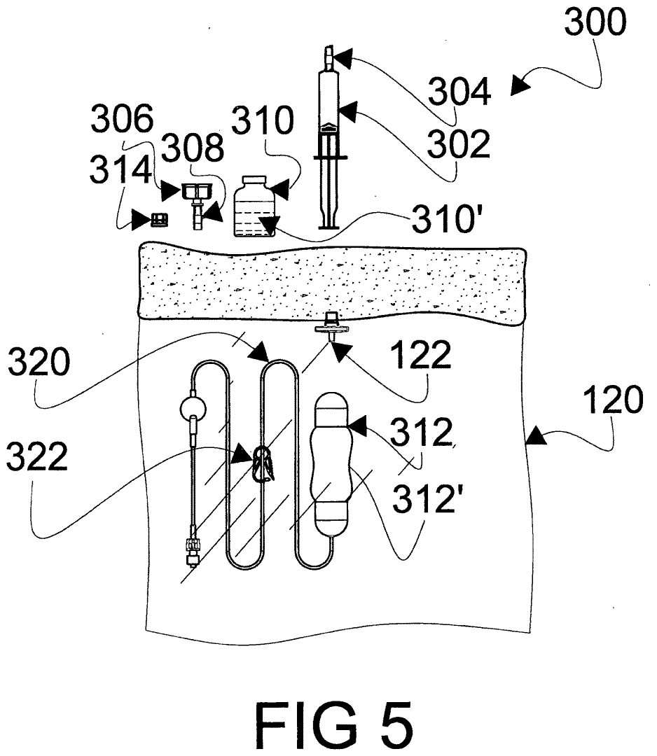

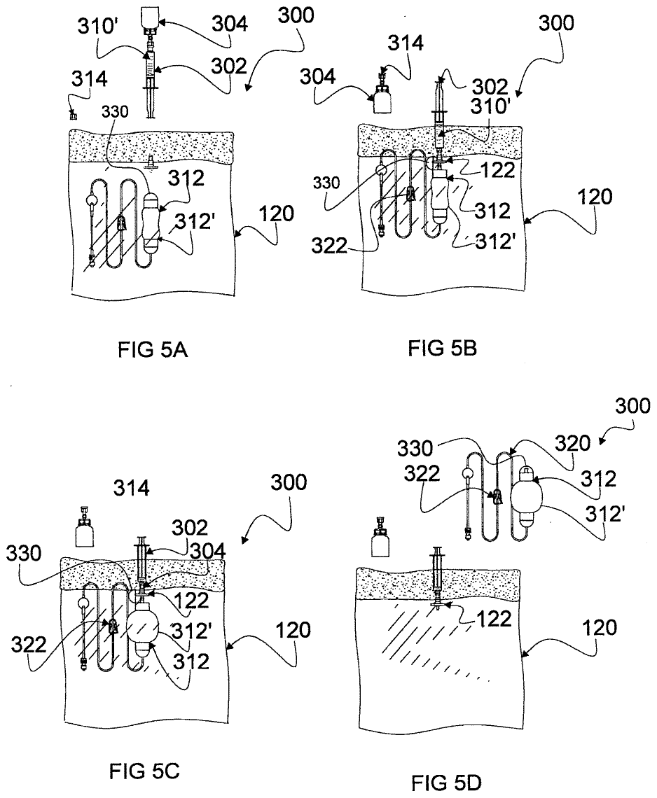

Reference is now made to FIG. 5 wherein a convenience kit 300 is seen to involve a group of exterior parts including a syringe 302 fitted with a dripless connector 304, a vial adapter 306 also fitted with a dripless connector 308. A vial 310 containing raw medicine 310′ and a cap 314 disposed exterior to a closed and sealed Header Bag 120, with a filter assembly 122 affixed thereto and containing a presterilized elastomeric ball assembly 312 with an elastomeric ball 312′ and an associated pre-capped IV set 320 with a pinch clamp 322 affixed to IV set 320. Assembly 312 elastomeric ball 312′ may be provided empty or with predetermined prescribed medicine. All surfaces interior to Header Bag 120, as is generally the case for Header Bag convenience kits made according to the present invention, are pre-sterilized by a sterilizing gas (e.g. Hydrogen Peroxide gas).

Reference is made to FIG. 5A, where a first filling step is accomplished by affixing syringe 302 to vial 304, for communicating raw medicine 310′ into syringe 302. With raw medicine 310′ disposed in syringe 302, as a second step, filled syringe 302 is affixed to filter assembly 122 as seen in FIG. 5B. Also, a protective cap 330 is displaced, permitting communication between filter assembly 122 and elastomeric ball 312′. A pinch valve 322, affixed IV set 320, provides a safeguard for assuring sterilized medicine 310′ (not shown) is retained in elastomeric ball 312′.

As a third step, seen in FIG. 5C, elastomeric ball 312′ is filled and inflated through a one-way valve disposed in elastomeric ball assembly 312 (not shown). The one-way valve is generally resident in all elastomeric ball fluid introduction pathways to eliminate blow-back. As seen in FIG. 5D, elastomeric ball assembly 312 is detached from filter assembly 122, protective cap 330 is reset and filled elastomeric ball 312′ is prepared for use.

### EXAMPLE 4: PREPARING A HAZARDOUS DRUG CONTAINING VESSEL AND IV LINE WITH A FLUSH SAFEGUARD

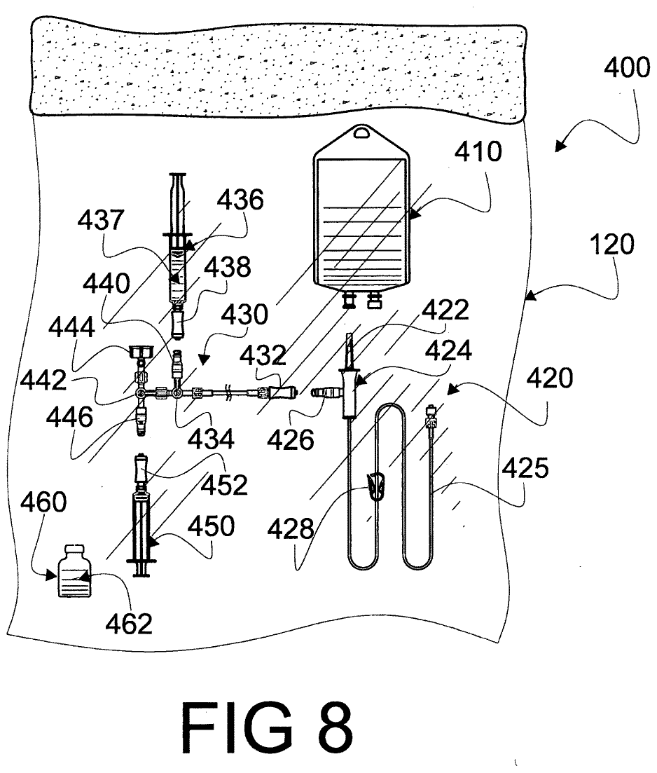

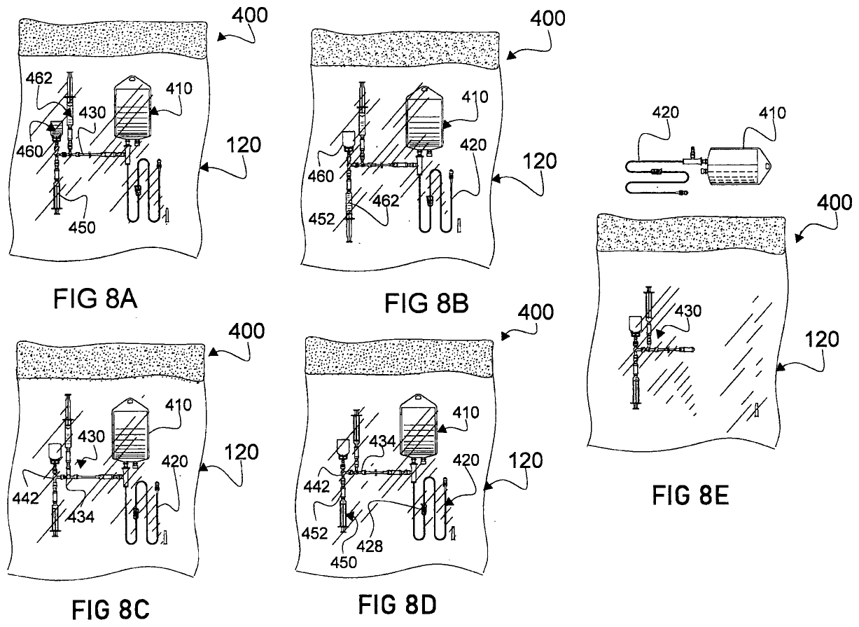

Reference is made to FIG. 8 wherein components are seen enclosed and exposed surfaces sterilized in Header Bag 120 of convenience kit 400.

FIG. 8 is a side elevation of a convenience kit 400 made according to the instant invention with all components being disposed within a Tyvek7 Header Bag 120, the components being:
(1) an Iv bag 410;
(2) an IV line assembly 420 fitted with an IV bag port access device 422 which is further affixed to a “T” connector 424 which joins an associated IV line 425 and a second dripless connector 426. Note that IV line 425 is fitted with a line flow impediment device 428;
(3) a fluid communicating assembly 430 comprising a dripless connector 432 which communicates with a stopcock 434 which selectively communicates with a flush syringe 436, containing a flush solution, through a pair of dripless connectors 438 and 440 to another stopcock 442 which communicates with a vial adapter 444 and another dripless connector 446;
(4) a medicine access syringe 450 also affixed to a dripless connector 452; and
(5) a pre-filled vial 460 comprising a fill of hazardous medicine 462, all such items being provided inside Header Bag 120.

FIG. 8A is similar to FIG. 8, but diminished in size, with the vial 460 being affixed to communicate with medicine access syringe 450 and joined to the fluid communicating assembly 430 for communicating medicine 462 into syringe 450.

FIG. 8B is similar to FIG. 8A, but with liquid 462 initially resident in vial 460 displaced into associated syringe 450.

FIG. 8C is similar to FIG. 8B with the first stopcock 434 adjusted to thereby communicate medicine 462 into IV bag 410.

FIG. 8D is similar to FIG. 8C except for stopcocks 434 and 438 being rotated to permit communication of flush solution through IV link 430 and IV set 420 as dispensed from syringe 436 with impediment device 428 open.

FIG. 8E is similar to FIG. 8D with combined fill IV set 410 and flushed IV line 420 removed from Header Bag 120 for use.

### EXAMPLE 5: USING A BAG CLIP FOR CONTROLLING ORDER OF COMPONENTS IN A HEADER BAG

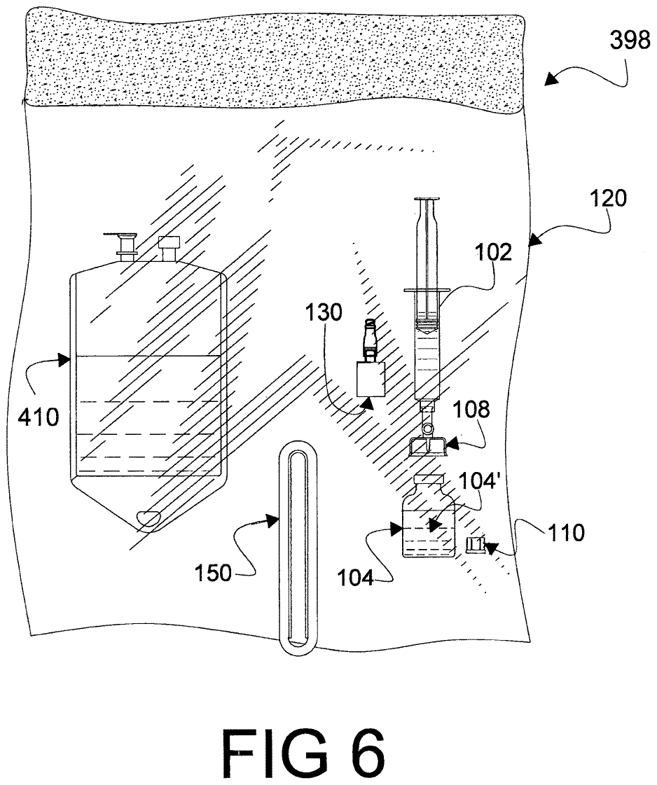

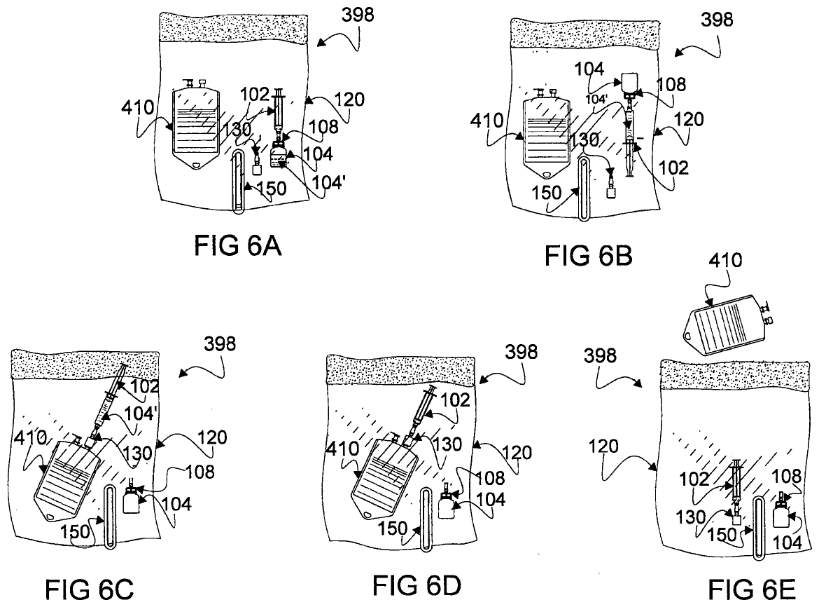

As might be anticipated, space within a Convenience Kit Header Bag is often at a premium providing a definite need for ordering to facilitate bag exterior contact in manipulating the components. To provide for control of component distribution, within a Header Bag 120, a bag clip 150 is affixed to Header Bag 120 in convenience kit 100′, as seen in FIG. 6.

Note, in FIG. 6 that sealed Header Bag 120 in convenience kit 398 contains not only an IV Bag 410, but also, a syringe numbered 102 fitted to a vial adapter 108, a port adapter 130, a vial 104 and a cap 110 with exterior surfaces sterilized as disclosed supra. In FIG. 6A, note that space is required to affix vial adapter 108 to vial 104 when affixed to syringe 102. For this purpose bag clip 150 is disposed away from the syringes and vials. In FIG. 6B, medicine is communicated from vial 104 into syringe 102 by inverting vial 104 and syringe 102. In FIG. 6C, bag clip 150 is displaced to provide more space for IV bag 410 involved activity. Thus, IV bag 410 is more facilely filled and accessed as seen in FIGS. 6D and 6E.

### Sterilization

A primary safeguard is accomplished through assured convenience kit sterilization. Sterilization is currently commercially accomplished for medical products using light (infra red), ethylene oxide (ETO) or radiation (commonly referenced as gamma). However, should a convenience kit include a medicine which is disposed within the sterilization field, each of the above sterilization methods are known to all too often negatively effect medicinal state and quality. For this reason, surface sterilization of closed vessels, using a sterilizing gas, has been selected as the sterilization mode of choice for kits made according to the present inventions.

Surface sterilization using Hydrogen Peroxide gas has proved effective in a vast assortment of applications and commercial sterilization of Header Bagged products is now commonly available. Currently, the Tyvek7 patch on a header bag provides a pathway for sterilizing gas and large sterilizing equipment, for this purpose, is commercially available, such as the Biodecontamination Unit made and sold by Steris Corporation.

The efficiency of such sterilizing equipment is dependent upon gas flow through the Header Bag Tyvek7 patch. To reach the highest efficiency, in some equipment, special ways of presenting a convenience kit and its internal components is desired. As an example, providing a product upright and hung can have an effect upon sterilization efficiency.

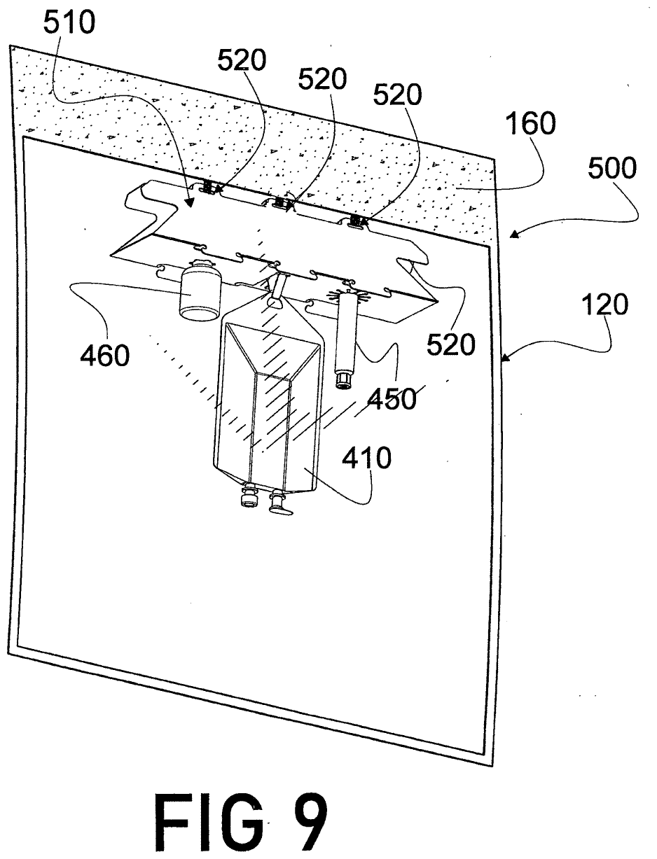

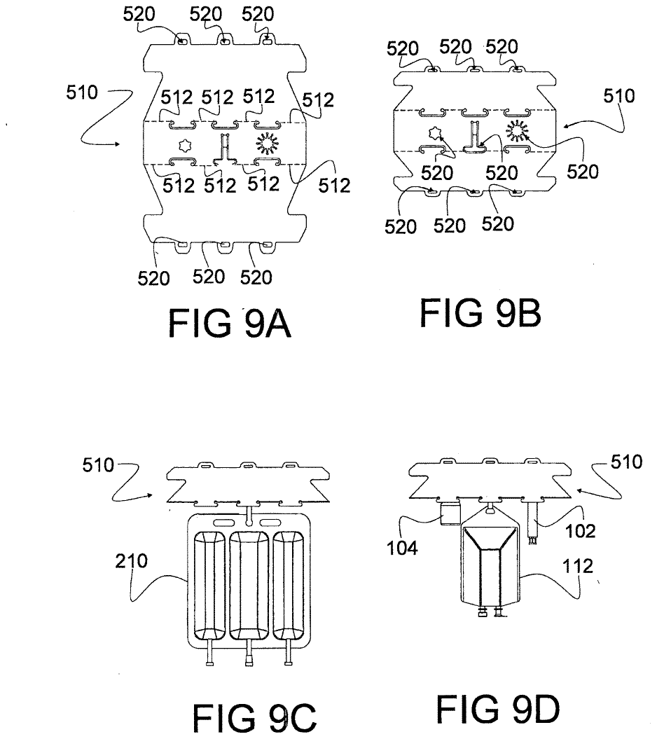

For this purpose a convenience kit 500 made according to the instant invention disclosed herein is provided in FIG. 9. A hangar 510 component, as seen in FIG. 9, can the used for assuring a desired sterilization safeguard is disposed within Header Bag 120 by deploying parts apart from compressed contact with the inner surface (not numbered) of Header Bag 120. An assembled hangar 510 which, for example, has a vial 460, an IV bag 410 and a syringe 450 affixed thereto and hung within a HEADER BAG 120 and hung by straps affixed to slots, commonly numbered 520, in hangar 510 and affixed to Header Bag 120 under Tyvek7 patch 530 is seen in FIG. 9.

A pre-formed hangar 510 can be selected and stamped from material which has sufficient durability to withstand transport and packaging forces, which can be folded and hung within a Header Bag and which does not sluff particulates can be prepared as seen stamped in FIG. 9A and folded as seen in FIG. 9B along dotted lines 510 and 512 as seen in FIG. 9A. A predetermined set of hanger patterns, commonly numbered 520 as seen in FIG. 9B, can be provided for releasably affixing components to hanger 510 as seen in FIGS. 9, 9C and 9D wherein a TPN module 210, a vial 104, an IV bag 112 and a syringe 102 are so modeled and affixed. As well, connecting slots 520 are likewise stamped for affixing hanger 510 within Header Bag 120.

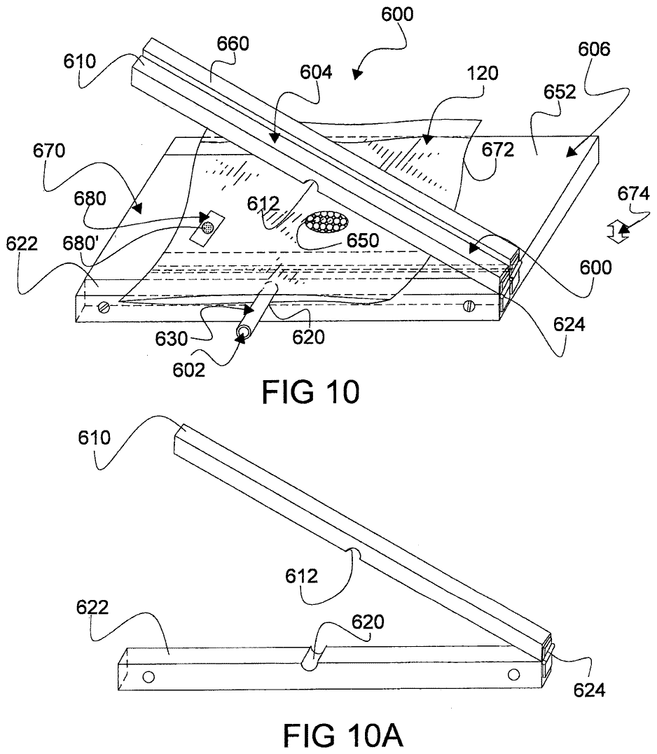

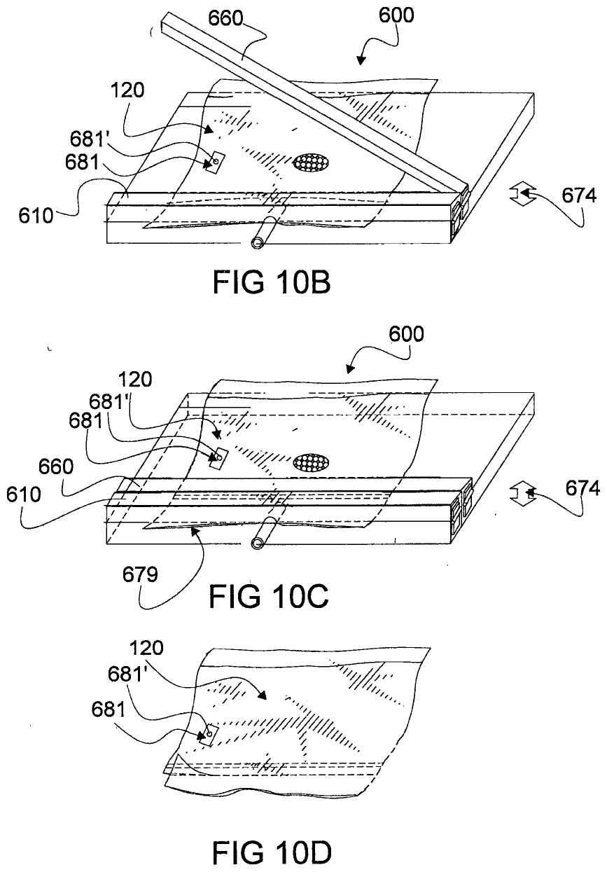

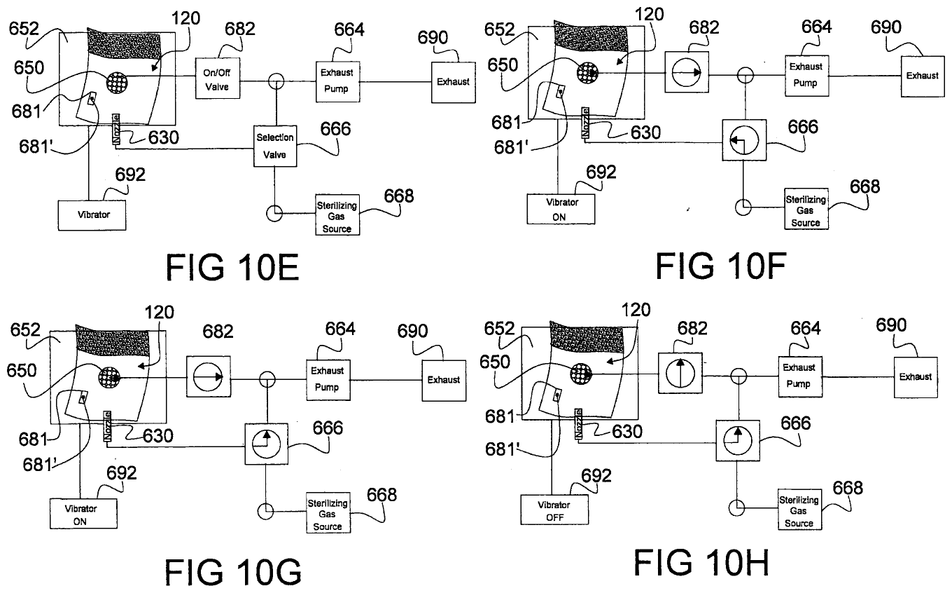

As mentioned supra, use of a Tyvek7 patch as a communicating pathway for sterilizing gas being communicated into a header bag for sterilizing components disposed therein has proved to be a challenging and costly problem to solve. An alternative method and associated sterilizing/bag sealing apparatus 600 which provides an open sterilizing gas pathway 602 is provided in FIG. 10. Apparatus 600 is made by combining a sterilizer apparatus 604 with a selected commercially available sealing apparatus 606. Sterilizer apparatus 604 is made according to instant invention disclosed hereafter.

Note that a proximal hinged bar 610 (of sterilizer apparatus 604) has a notch 612 which is one of two opposing notches. The second notch 620, disposed in a base bar 622, and affixed to bar 610 by a hinge 624, is hidden by a nozzle 630 disposed therein. Nozzle 630 provides access pathway 602 for sterilizing gas, being disposed for providing a single pathway for sterilizing gas communicated into an as yet unsealed Header Bag 120. Header Bag 120 is provided without components disposed therein for clarity of presentation.

Note also a holed plate 650 disposed in the center of a bag supporting platform 652 under Header Bag 120. A second bar 660 represents a bar used as a sealing implement of a commercial quality bag sealer 606 which provides supporting platform 652. Holed plate 650 is made a part of supporting platform 652 to provide a low pressure source applied to a bottom 672 of Header Bag 120. Applying a lower than atmospheric pressure via holed plate 650 provides a desired anchor to keep Header Bag in place during sterilization and sealing. A mechanism which is unseen, but well understood by those who are skilled in mechanical art, is a vibrator affixed to the support platform for providing cyclic vibrations to supporting platform 652 and the bottom 672 of Header Bag 120. The cyclic vibrations are applied in line with gravitational force as indicated by double arrow 674 and provide sufficient displacement to assure sterilization of all surfaces within Header Bag 120.

A portion of sterilizer apparatus 604 is seen apart in FIG. 10A for ducts 612 and 620 clarification. Note that both ducts are in-line and sized and shaped to close about nozzle 630 and associated Header Bag material.

As seen in FIG. 10B, proximal bar 610 is displaced to provide a pressure seal about Header Bag 120 opening 680 (seen in FIG. 10). The pressure seal is made effective by pliancy of Header Bag material and size and form of notches 612 and 620 about nozzle 630 as seen in FIG. 10C. Also a sterilization test strip 681 with a sterilization status indicator 681′ is disposed within Header Bag 120 for indicating sterilization state as yet another safeguard.

Reference is now made to block diagrams FIGS. 10E-10H wherein operational features of sterilizer apparatus 604 are disclosed. As seen in FIG. 10E, function of holed plate 650 for anchoring Header Bag 120 is controlled by valve 682, which is turned on after Header Bag 120 is disposed on supporting platform 652. A vacuum pump 664 draws fluid from valve 682 to an exhaust apparatus 690, which should be out to open air and meet all appropriate regulations.

Selection valve 666 controls flow from nozzle 630 to vacuum pump 664 as seen in FIG. 10G. By a different setting selection valve 666 directs flow from a pumped source of sterilizing gas 668 to nozzle 630 as seen in FIG. 10F. Such sterilizing gas sources are commercially available.

A sterilizing cycle involves states of operation as seen in FIGS. 10F and 10G. In FIG. 10F, valve 682 is open to exhaust pump 664 to assure anchoring of Header Bag 120. Valve 666 is open to nozzle 630 for displacing sterilizing gas into Header Bag 120 to inflate Header Bag 120 thus providing a sterilizing period. As a second phases of the sterilizing cycle, operation as disclosed in FIG. 10G illustrates valve 666 open to exhaust pump 664 for deflating Header Bag 120 by drawing gas therefrom.

The completion of sterilization can be determined by one or more strategically disposed test strips as exemplified by test strip 680, seen in FIG. 10. Such test strips are available commercially and provide a sterilization indication of a change of color of a test spot, such as spot 680′, when reaching a predetermined SAL.

### EXAMPLE 6: REPACKAGING MEDICINE FROM SOURCE CONTAINERS INTO SYRINGES

In current medicine, the single most common means for delivering liquid medicine to a patient is via syringe. For this reason, syringes filled with repackaged medicine are employed in very large quantities daily worldwide. Repackaging and compounding requirements for individual patient treatment include assurance that the quality of medicine provided in source containers (received from medicine manufactures) is handled without change in medicinal quality or sterility.

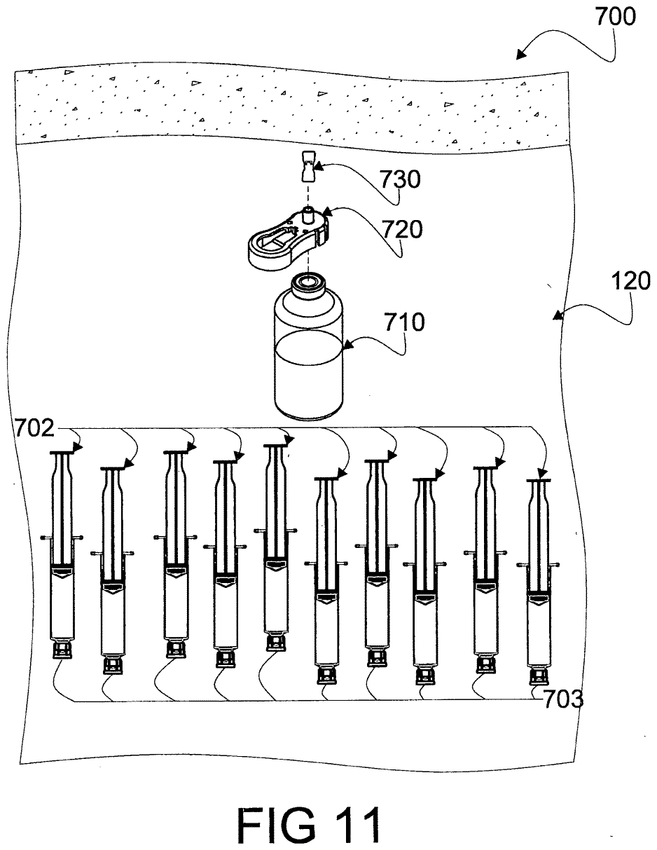

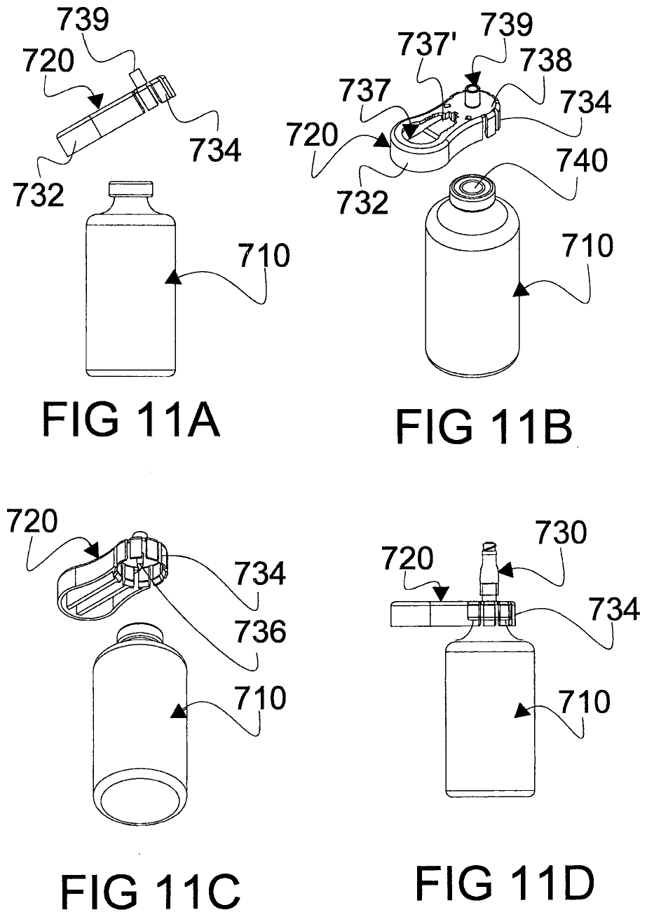

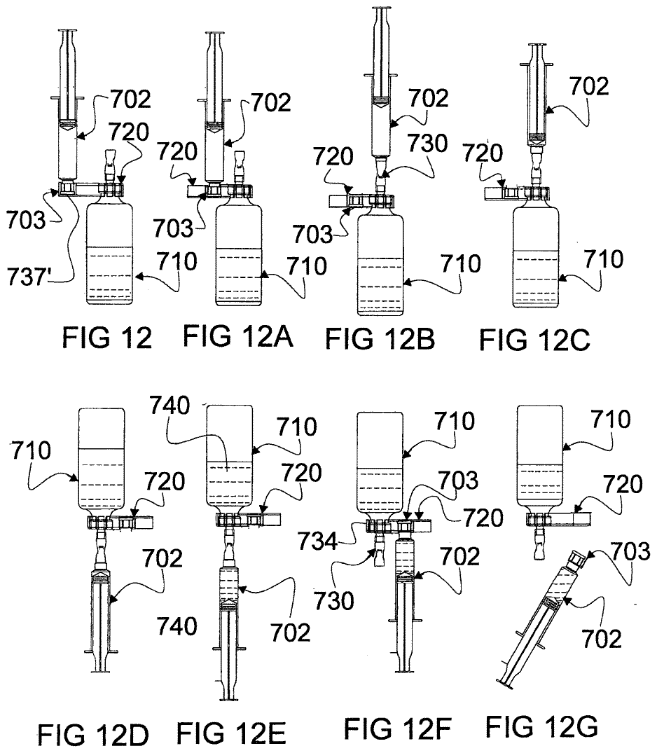

Reference is now made to FIGS. 11-12G wherein disclosure of methods and devices associated with handling and repackaging medicine according to the instant inventions disclosed herein is provided. As seen in FIG. 11, a convenience kit 700 made according to instant invention disclosed herein is seen. In this example, kit 700 comprises a Header Bag 120 in which a plurality of empty sterilized syringes, each numbered 702 and closed by a cap 703, respectively, a source container 710, a tool 720 for accessing both source container 710 and each syringe 702 and a dripless connector 730.

Hereafter, tool 720 is referenced by either TASCS 720 which is an acronym for “Tool for Accessing a Source Container and Syringes or tool 720. TASCS 720 basically serves two purposes, i.e. (1) providing access to a source container and (2) providing cap handling access for each syringe 702, individually, as the syringe is being decapped, filled and recapped. As seen in FIG. 11A, TASCS 720 has two basic parts, a syringe cap handing and holding section 732 and a vial interfacing section 734. As seen in FIGS. 11B and 11C, section 734 has the form of a vial adapter with a septum piercing needle 740 disposed for opening a liquid pathway 739 to vial 710 as seen in FIGS. 11B and 11C.

If the source container were different such as being in the form of an IV bag, the form of section 734 should be modified such as being in the form of an IV adapter port in the case of the source container being an IV bag. An orifice 737 provides an entry pathway for a syringe cap 703. A cap holding section 737′ provides for holding cap 703 while syringe 702 is displaced therefrom for filling, see FIGS. 12B-12E.

Reference is made to FIGS. 12-12G wherein steps associated with filling a syringe 702 are seen. It should be noted that steps identified in FIGS. 12-12G are all performed inside closed and sealed Header Bag 120. As seen in FIG. 12, cap 703, affixed to syringe 702, is disposed in orifice 737′ of TASCS 720 as a first filling step. As a second step, syringe 702 and cap 703 are displaced into cap holding section 737′ in FIG. 12A. Syringe 702 is displaced from cap 703 and affixed to dripless connector 730 in FIG. 12B. Note: Dripless connectors are available commercially as CLAVE components from ICU Medical, a US company. Gas present in syringe 702 is then dispensed into vial 710 as seen in FIG. 12C to provide matter for keeping pressure in vial 710 nearly constant through the syringe filling process.

Syringe 702 and vial 710 are then inverted as seen in FIG. 12D. A measured volume of medicine is drawn into syringe 702 as seen in FIG. 12E. So filled syringe 702 is detached from vial adapter 734 and dripless connector 730 as seen in FIG. 12F. Note that the major reason for dripless connector 730 is to eliminate the possibility of spillage when removing filled syringe 702. Syringe 702 is recapped as seen in FIG. 12F.

Recapped syringe 702 with cap 703 closing syringe 702 and providing a safeguard for, with assurance of safety, displacing filled syringe 702 into a potentially contaminating environment before use.

After filling of a first syringe, the number of next filling steps can be reduced by connecting an empty syringe 702 as seen in FIG. 12D, dispensing gas from the just connected syringe 702 and proceeding through steps identified in FIGS. 12E to 12G.

Inventions disclosed herein may be embodied in other specific forms without departing from the spirit or essential characteristics thereof. The present embodiments are therefore to be considered in all respects as illustrative and not restrictive, the scope of each invention being indicated by the appended claims rather than by the foregoing description, and all changes which come within the meaning and range of equivalency of the claims are therefore intended to be embraced therein.

What is claimed and desired to be secured by Letters Patent is:

1. A convenience kit for preparing medicine, used in patient treatment, that cannot be further sterilized, said convenience kit comprising inherent safeguards for assuring medicinal quality of said medical preparation is: not adversely affected by medicine preparation, said convenience kit comprising:
a Header Bag in which said medicine is prepared, said Header Bag, as a safeguard, being closed and sealed about vessels requisite for preparing said medicine for patient treatment which are closed, sealed and pre-sterilized and disposed therein along with at least one source vessel containing said medicine also provided closed and sealed as a further safeguard; and
all exposed surfaces inside said Header Bag being sterilized by a sterilizing gas such that medicine inside the source vessel is neither in contact with nor affected by said sterilizing gas and thereby protected by a resulting safeguard against cross contamination due to contact only between sterilized exposed surfaces.

2. A method for preparing a convenience kit made according to claim 1 for use by sterilizing all exposed surfaces internal to said Header Bag by performing the following steps:
a. providing a control system whereby a controlled volume of sterilizing gas is displaced into and removed from said Header Bag;
b. providing a measurement instrument for determining SAL resulting from contact with said sterilizing gas;
c. displacing said predetermined volume of sterilizing gas into said Header Bag which is closed except for a pathway for introduction and removal of said sterilizing gas;
e. displacing said predetermined volume of sterilizing gas from said header bag;
f. reading a measurement of sterility provided by said instrument to determine SAL status;
g. if a desired SAL has not been reached, as a safeguard go to step c;
h. close and seal said Header Bag to prepare said convenience kit for shipment to a user site.

3. A hybrid convenience kit for preparing medicine, used in patient medicine preparation made according to claim 1 wherein a filter assembly is affixed to said Header Bag for introducing only sterile matter into said Header Bag as a safeguard for maintaining sterility within said Header Bag and in a resulting medical preparation.

4. A convenience kit made according to claim 1 wherein a requisite patient medicine providing vessel is a vessel selected from a group of vessels comprising a TPN module, an elastomeric ball, an IV bag and at least one syringe.

5. A TASCS tool for an aid in decapping and capping each patient syringe disposed in a convenience kit made according to claim 1 and providing access to a port accessible container for providing a communication pathway for medicine dispensed from said port accessible container into said patient syringe.

6. A method for sterilizing surfaces of medicine containing vessels and other components disposed into a Header Bag comprising the following steps:
providing all of said medicine containing containers disposed within said Header Bag closed and sealed to assure quality and sterility of medicine disposed therein is maintained and displacing at least one sterilization measuring strip into said Header Bag for visual verification of desired SAL;
disposing said so-filled Header Bag onto a support structure associated with a Header Bag sealer;
providing for a sterilizing grade gas to be communicated into said Header Bag through an unclosed portion of said Header Bag;
providing a vibration mechanism which communicates with said supporting structure for providing cyclic pulsation to each said Header Bag and contents therein for momentary displacement of contacting surfaces to assure function of a safeguard for completely sterilizing all surfaces within said Header Bag;
displacing said sterilizing grade fluid into each at least one said Header Bag;
actuating said vibration mechanism; and
continuing sterilizing until all surfaces are sterilized thereby providing an effective safeguard against contact contamination.

7. A method for sterilizing surfaces of medicine containing vessels and other components according to claim 6 wherein said sterilizing grade fluid is Hydrogen Peroxide.

8. A method for sterilizing surfaces of medicine containing vessels and other components according to claim 6 wherein said providing steps comprise an additional step of providing a sterilized state measurement indicator disposed within said Header Bag, and visible from outside said Header Bag, for physically measuring and communicating degree of sterilization to thereby permit continuing sterilization activity until a predetermined sterility state is achieved.

9. A method for sterilizing surfaces of medicine containing vessels and other components according to claim 8 wherein said state measurement indicator is an ATTEST® bleach sensitive indicator slip which provides a color change indication of sterility state.

10. A method for sterilizing surfaces of medicine containing vessels and other components according to claim 6 wherein said providing exteriorly exposed Header Bag affixing feature step comprises providing a Header Bag orifice covering plate and vacuum producing pumping system whereby the exterior of said Header Bag is securely affixed to said supporting structure.
